(19) United States
(12) Patent Application Publication
(10) Pub. No.: US 2026/0044035 A1
(43) Pub. Date: Feb. 12, 2026

(54) ELECTRONIC DEVICE

(71) Applicant: InnoLux Corporation, Miao-Li County (TW)

(72) Inventors: Ming-Che HUANG, Miao-Li County (TW); An-Cheng CHENG, Miao-Li County (TW); Chi-Chau LIN, Miao-Li County (TW)

(21) Appl. No.: 19/262,241

(22) Filed: Jul. 8, 2025

(30) Foreign Application Priority Data
Aug. 8, 2024 (CN) 202411084096.4

(51) Int. Cl. G02F 1/1333; E06B 3/66; E06B 3/663; E06B 3/67; G02F 1/1339

(52) U.S. Cl. CPC G02F 1/133382; E06B 3/6612; E06B 3/66342; E06B 3/6722; G02F 1/1339; G02F 2201/50

(57) ABSTRACT

An electronic device includes: a first light-transmitting element; a second light-transmitting element disposed opposite to the first light-transmitting element; and a switchable light control element disposed between the first light-transmitting element and the second light-transmitting element; wherein a first chamber is between the first light-transmitting element and the switchable light control element, a second chamber is between the second light-transmitting element and the switchable light control element, and the switchable light control element includes at least one of a light absorption switching element and a light scattering switching element.

### CROSS-REFERENCE TO RELATED APPLICATIONS

This application claims the benefits of the Chinese Patent Application Ser. No. 20/241,1084096.4, filed on Aug. 8, 2024, the subject matter of which is incorporated herein by reference.

### BACKGROUND

### Field

The present disclosure provides an electronic device. More specifically, the present disclosure provides an electronic device comprising a switchable light control element.

### Description of Related Art

In recent years, smart windows or other electronic devices with adjustable light transmitting states (such as light transmitting state, dark state, foggy state, etc. that the light transmittance is changed) have been widely used. Such electronic devices are expected to be able to achieve adjustable light transmittance, light shielding (dark state) or foggy state while also taking into account heat insulation and/or sound insulation.

However, such electronic devices still have disadvantages such as poor heat insulation and/or sound insulation. Therefore, it is desirable to provide an electronic device to solve the previous defects.

### SUMMARY

The present disclosure provides an electronic device, comprising: a first light-transmitting element; a second light-transmitting element opposite to the first light-transmitting element; and a switchable light control element disposed between the first light-transmitting element and the second light-transmitting element, wherein a first chamber is between the first light-transmitting element and the switchable light control element, a second chamber is between the second light-transmitting element and the switchable light control element, and the switchable light control element comprises at least one of a light absorption switching element and a light scattering switching element.

The present disclosure further provides another electronic device, comprising: a light-transmitting element; a first switchable light control element opposite to the light-transmitting element; and a second switchable light control element disposed between the light-transmitting element and the first switchable light control element, wherein a first chamber is between the light-transmitting element and the second switchable light control element, a second chamber is between the first switchable light control element and the second switchable light control element, the first switchable light control element comprises one of a light absorption switching element and a light scattering switching element, and the second switchable light control element comprises the other one of the light absorption switching element and the light scattering switching element.

The present disclosure further provides another electronic device, comprising: a first switchable light control element; a second switchable light control element opposite to the first switchable light control element; and a light-transmitting element disposed between the first switchable light control element and the second switchable light control element, wherein a first chamber is between the first switchable light control element and the light-transmitting element, a second chamber is between the second switchable light control element and the light-transmitting element, the first switchable light control element comprises one of a light absorption switching element and a light scattering switching element, and the second switchable light control element comprises the other one of the light absorption switching element and the light scattering switching element.

Other novel features of the disclosure will become more apparent from the following detailed description when taken in conjunction with the accompanying drawings.

### BRIEF DESCRIPTION OF DRAWINGS

FIG. 1 is a cross-sectional schematic view of an electronic device according to one embodiment of the present disclosure.

FIG. 2 is a three-dimensional schematic view of a light-transmitting element according to one embodiment of the present disclosure.

FIG. 3A and FIG. 3B are schematic views of a light absorption switching element according to one embodiment of the present disclosure.

FIG. 4A and FIG. 4B are schematic views of a light scattering switching element according to one embodiment of the present disclosure.

FIG. 5 is a cross-sectional schematic view of an electronic device according to one embodiment of the present disclosure.

FIG. 6 is a cross-sectional schematic view of an electronic device according to one embodiment of the present disclosure.

FIG. 7 is a cross-sectional schematic view of an electronic device according to one embodiment of the present disclosure.

FIG. 8 is a cross-sectional schematic view of an electronic device according to one embodiment of the present disclosure.

FIG. 9 is a cross-sectional schematic view of an electronic device according to one embodiment of the present disclosure.

FIG. 10 is a cross-sectional schematic view of an electronic device according to one embodiment of the present disclosure.

FIG. 11 is a cross-sectional schematic view of an electronic device according to one embodiment of the present disclosure.

### DETAILED DESCRIPTION

The following is specific embodiments to illustrate the implementation of the present disclosure. Those who are familiar with this technique can easily understand the other advantages and effects of the present disclosure from the content disclosed in the present specification. The present disclosure can also be implemented or applied by other different specific embodiments, and various details in the present specification can also be modified and changed according to different viewpoints and applications without departing from the spirit of the present disclosure.

It should be noted that, in the present specification, when a component is described to have an element, it means that the component may have one or more of the elements, and it does not mean that the component has only one of the element, except otherwise specified. Furthermore, the ordinals recited in the specification and the claims such as “first”, “second” and so on are intended only to describe the elements claimed and imply or represent neither that the claimed elements have any proceeding ordinals, nor that sequence between one claimed element and another claimed element or between steps of a manufacturing method. The use of these ordinals is merely to differentiate one claimed element having a certain designation from another claimed element having the same designation.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

The terms, such as “about”, “substantially”, or “approximately”, are generally interpreted as within 10%, 5%, 3%, 2%, 1%, or 0.5% of a given value or range. The quantity given here is an approximate quantity, that is, without specifying “about”, “approximately”, “substantially” and “approximately”, “about”, “approximately”, “substantially” and “approximately” can still be implied. Furthermore, when a value is “in a range from a first value to a second value” or “in a range between a first value and a second value”, the value can be the first value, the second value, or another value between the first value and the second value.

In the present specification, except otherwise specified, the terms (including technical and scientific terms) used herein have the meanings generally known by a person skilled in the art. It should be noted that, except otherwise specified, in the embodiments of the present disclosure, these terms (for example, the terms defined in the generally used dictionary) should have the meanings identical to those known in the art, the background of the present disclosure or the context of the present specification, and should not be read by an ideal or over-formal way.

In addition, relative terms such as “below” or “under” and “on”, “above” or “over” may be used in the embodiments to describe the relative relationship between one element and another element in the drawings. It will be understood that if the device in the drawing was turned upside down, elements described on the “lower” side would then become elements described on the “upper” side. When a unit (for example, a layer or a region) is referred to as being “on” another unit, it can be directly on the another unit or there may be other units therebetween. Furthermore, when a unit is said to be “directly on another unit”, there is no unit therebetween. Moreover, when a unit is said to be “on another unit”, the two have a top-down relationship in a top view, and the unit can be disposed above or below the another unit, and the top-bottom relationship depends on the orientation of the device.

It should be understood that according to the embodiments of the present disclosure, an optical microscope (OM), a scanning electron microscope (SEM), a film thickness profiler (α-step), an ellipsometer, or other suitable methods may be used to measure the thickness, width of each element or the distance between elements. According to some embodiments, a scanning electron microscope may be used to obtain a cross-sectional structure image including an element to be measured, and the thickness and width of each element or the distance between elements can be measured. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°.

The electronic device of the present disclosure may include, for example, a display device, a backlight device, an antenna device, a sensing device or a tiled device, but the present disclosure is not limited thereto. The electronic device may be a flexible or bendable electronic device. The display device may be a non-self-luminous display device or a self-luminous display device. The antenna device may be a liquid crystal type antenna device or a non-liquid crystal type antenna device. The sensing device can be a sensing device that senses capacitance, light, heat or ultrasound. However, the present disclosure is not limited thereto. The electronic components may include passive components and active components, such as capacitors, resistors, inductors, diodes, transistors, etc. The diode may include a light emitting diode or a photodiode. The light emitting diode may include, for example, an organic light emitting diode (OLED), a mini LED, a micro LED, or a quantum dot LED, but the present disclosure is not limited thereto. The tiled device may be, for example, a tiled display device or a tiled antenna device, but the present disclosure is not limited thereto. It should be noted that the electronic device can be any arrangement or combination of the aforementioned, but the present disclosure is not limited thereto. The following description will use a display device as an electronic device or a tiled device to illustrate the present disclosure, but the present disclosure is not limited thereto.

In addition, the shape of the electronic device may be rectangular, circular, polygonal, a shape with curved edges, or other suitable shapes. The electronic device may have peripheral systems such as a processing system, a driving system, a control system, a light source system, a shelf system, etc. to support the display device or the tiled device.

It should be noted that the technical solutions provided in the following different embodiments can be replaced, combined or mixed with each other to form another embodiment without violating the spirit of the present disclosure.

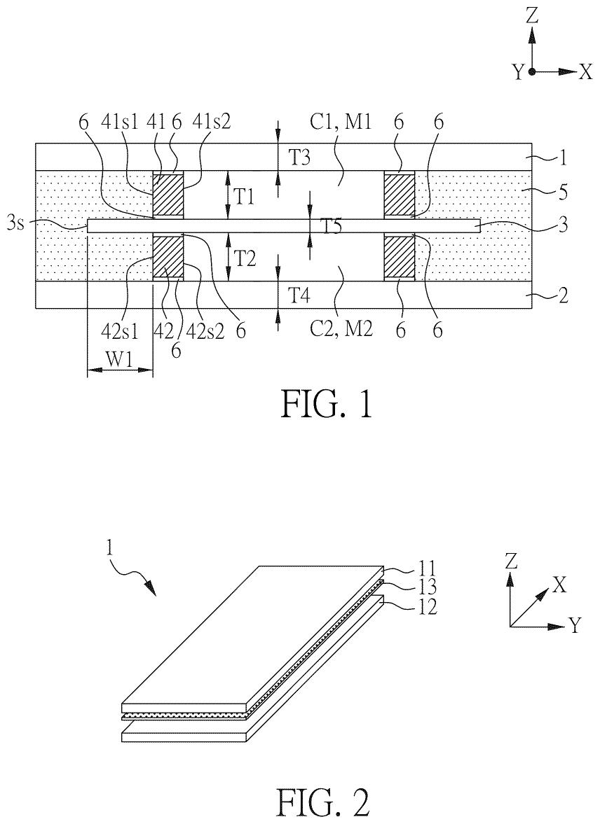

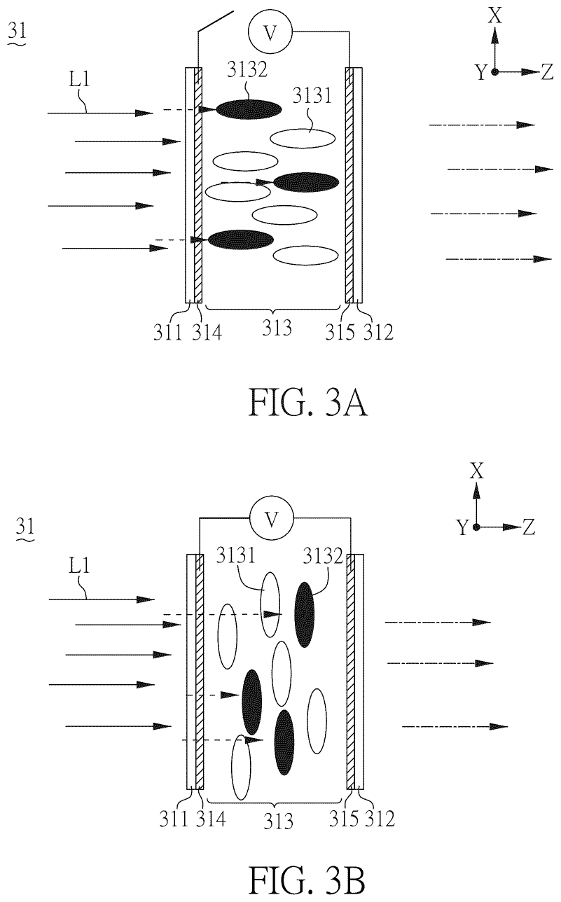

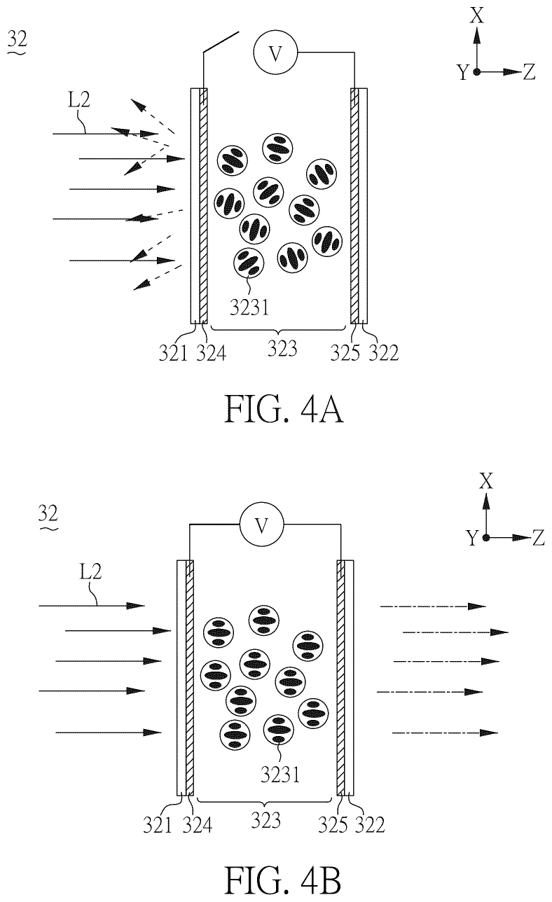

FIG. 1 is a cross-sectional schematic view of an electronic device according to one embodiment of the present disclosure. FIG. 2 is a three-dimensional schematic view of a light-transmitting element according to one embodiment of the present disclosure. FIG. 3A and FIG. 3B are schematic views of a light absorption switching element according to one embodiment of the present disclosure. FIG. 4A and FIG. 4B are schematic views of a light scattering switching element according to one embodiment of the present disclosure.

In one embodiment of the present disclosure, as shown in FIG. 1, the electronic device may comprise: a first light-transmitting element 1; a second light-transmitting element 2 opposite to the first light-transmitting element 1; and a switchable light control element 3 disposed between the first light-transmitting element 1 and the second light-transmitting element 2, wherein a first chamber C1 is between the first light-transmitting element 1 and the switchable light control element 3, a second chamber C2 is between the second light-transmitting element 2 and the switchable light control element 3, and the switchable light control element 3 comprises at least one of a light absorption switching element and a light scattering switching element.

In one embodiment of the present disclosure, as shown in FIG. 1, the electronic device may comprise: a first frame 41 disposed between the first light-transmitting element 1 and the switchable light control element 3 to form the first chamber C1; a second frame 42 disposed between the second light-transmitting element 2 and the switchable light control element 3 to form the second chamber C2; and a protective structure 5 disposed between the first light-transmitting element 1 and the second light-transmitting element 2, wherein the protective structure 5 covers a side of the first frame 41 (for example, the first outer side 41s1) and a side of the second frame 42 (for example, the second outer side 42s1). More specifically, in the present disclosure, the first frame 41 and the second frame 42 may respectively have a surrounding structure, which may have, for example, different designs according to the appearance of the electronic device. Thus, in the cross-sectional view (for example, FIG. 1), the first frame 41 may have a first outer side 41s1 and a first inner side 41s2, and the second frame 42 may have a second outer side 42s1 and a second inner side 42s2, wherein the protective structure 5 may respectively contact the first outer side 41s1 of the first frame 41 and the second outer side 42s1 of the second frame 42, but the present disclosure is not limited thereto. In the present disclosure, the first outer side 41s1 and the second outer side 42s1 may be approximately aligned, but the present disclosure is not limited thereto. In the present disclosure, the first inner side 41s2 and the second inner side 42s2 may be approximately aligned, but the present disclosure is not limited thereto. In other embodiments (not shown in the figure), the first outer side 41s1 and the second outer side 42s1 may not be aligned, and the first inner side 41s2 and the second inner side 42s2 may not be aligned. In other embodiments (not shown in the figure), other material layers (for example, a water barrier layer or an adhesion layer, but the present disclosure is not limited thereto) may be selectively disposed between the protective structure 5 and the first outer side 41s1 of the first frame 41 and between the protective structure 5 and the second outer side 42s1 of the second frame 42, but the present disclosure is not limited thereto. In addition, the electronic device may further comprise: a first thermal resistance material M1 disposed in the first chamber C1; and a second thermal resistance material M2 disposed in the second chamber C2, wherein the first inner side 41s2 of the first frame 41 may contact the first thermal resistance material M1, and the second inner side 42s2 of the second frame 42 may contact the second thermal resistance material M2, but the present disclosure is not limited thereto.

In the electronic device of the present disclosure, the switchable light control element 3 is assembled with two light-transmitting elements (for example, the first light-transmitting element 1 and the second light-transmitting element 2) to form two chambers (for example, the first chamber C1 and the second chamber C2), and the chamber is filled with appropriate thermal resistance material, so the electronic devices may achieve the effects of heat insulation, sound insulation, blocking external light or penetrating external light, but the present disclosure is not limited thereto. In the present disclosure, more switchable light control elements 3 may be assembled with two light-transmitting elements (for example, the first light-transmitting element 1 and the second light-transmitting element 2) to form more chambers according to the needs.

In the present disclosure, the first light-transmitting element 1 and/or the second light-transmitting element 2 may have single or multi-layer structure. For example, in one embodiment of the present disclosure, as shown in FIG. 2, the first light-transmitting element 1 may comprise: a first substrate 11; a second substrate 12 disposed opposite to the first substrate 11; and an adhesion layer 13 disposed between the first substrate 11 and the second substrate 12. In one embodiment of the present disclosure, the second light-transmitting element 2 may also have the multi-layer structure as shown in FIG. 2, and is not described again here. In one embodiment of the present disclosure, the first light-transmitting element 1 and the second light-transmitting element 2 may respectively have the multi-layer structure as shown in FIG. 2, and is not described again here. When the light-transmitting element has the multi-layer structure, the thermal or sound insulation of the electronic device can be improved. In the present disclosure, the same or different materials may be used to prepare the first substrate 11 and the second substrate 12, and the materials of the first substrate 11 and the second substrate 12 may respectively comprise glass, quartz, sapphire, ceramics, polycarbonate (PC), polyimide (PI), polyethylene terephthalate (PET), polymethylmethacrylate (PMMA), other suitable substrate materials or a combination thereof, but the present disclosure is not limited thereto. In the present disclosure, the material of the adhesion layer 13 may comprise polyvinyl butyral (PVB), ethylene vinyl acetate (EVA), optical clear adhesive (OCA), optical clear resin (OCR), other suitable material or a combination thereof, but the present disclosure is not limited thereto. The adhesion layer 13 may be used to attach the first substrate 11 and the second substrate 12. In one embodiment, the adhesion layer 13 may selectively have anti-UV effect, and for example, the penetration rate of UV light can be less than 50%, but the present disclosure is not limited thereto. In the present disclosure, the thickness T3 of the first light-transmitting element 1 and the thickness T4 of the second light-transmitting element 2 may be the same or different, and the thickness T3 of the first light-transmitting element 1 and the thickness T4 of the second light-transmitting element 2 may be respectively between 3 mm to 30 mm (that is, 3 mm≤T3≤30 mm, 3 mm≤T4≤30 mm), between 3 mm to 25 mm (that is, 3 mm≤T3≤25 mm, 3 mm≤T4≤25 mm), between 3 mm to 20 mm (that is, 3 mm≤T3≤20 mm, 3 mm≤T4≤20 mm), or between 3 mm to 15 mm (that is, 3 mm≤T3≤15 mm, 3 mm≤T4≤15 mm). The “thickness of the light-transmitting element” refers to, for example, the average distance between the upper surface and the lower surface of the light-transmitting element at any three points in the normal direction Z of the first light-transmitting element 1 or the second light-transmitting element 2 (that is, in a cross-section).

In the present disclosure, the same or different materials may be used to prepare the first frame 41 and the second frame 42, and the materials of the first frame 41 and the second frame 42 may respectively include metal, plastic, ceramics, other suitable materials or a combination thereof, but the present disclosure is not limited thereto. In the present disclosure, the protective structure 5 may comprise a transparent or non-transparent material, and for example, the protective structure 5 may comprise black, white or transparent material. The protective structure 5 may be used to fix the first light-transmitting element 1, the second light-transmitting element 2 and/or the switchable light control element 3, reduce the penetration of air or moisture into the first chamber C1 and/or the second chamber C2, or improve the sound insulation or heat insulation effect of the electronic device.

In the present disclosure, as shown in FIG. 1, in the normal direction Z of the first light-transmitting element 1, the first chamber C1 has a first thickness T1, the second chamber C2 has a second thickness T2, and the first thickness T1 and the second thickness T2 may be respectively greater than or equal to 1 mm and less than or equal to 22 mm (that is, 1 mm≤T1≤22 mm, 1 mm≤T2≤22 mm), greater than or equal to 1 mm and less than or equal to 20 mm (that is, 1 mm≤T1≤20 mm, 1 mm≤T2≤20 mm), greater than or equal to 1 mm and less than or equal to 18 mm (that is, 1 mm≤T1≤18 mm, 1 mm≤T2≤18 mm), or greater than or equal to 3 mm and less than or equal to 20 mm (that is, 3 mm≤T1≤20 mm, 3 mm T2≤20 mm), or the first thickness T1 and the second thickness T2 may be respectively greater than or equal to 6 mm and less than or equal to 20 mm (that is, 6 mm≤T1≤20 mm, 6 mm≤T2≤20 mm), but the present disclosure is not limited thereto. When the thicknesses of the first chamber C1 and the second chamber C2 meets the aforesaid limitations, the electronic device can be thinner while the sound insulation or heat insulation effect of the electronic device can also be ensured. The “first thickness” refers to, for example, the average distance between the first light-transmitting element 1 and the switchable light control element 3 at any three points in the normal direction Z of the first light-transmitting element 1 (that is, in the cross-section). The “second thickness” refers to, for example, the average distance between the second light-transmitting element 2 and the switchable light control element 3 at any three points in the normal direction Z of the first light-transmitting element 1 (that is, in the cross-section).

In the present disclosure, the first thermal resistance material M1 and the second thermal resistance material M2 may be the same or different, and the thermal conductivity of the first thermal resistance material M1 and the second thermal resistance material M2 may respectively be less than 50×10⁻³ W·m⁻¹·K⁻¹. In some disclosures, the thermal conductivity of the first thermal resistance material M1 and the second thermal resistance material M2 may respectively be less than 45×10⁻³ W·m⁻¹·K⁻¹. In some disclosures, the thermal conductivity of the first thermal resistance material M1 and the second thermal resistance material M2 may respectively be less than 40×10⁻³ W·m⁻¹·K⁻¹. The first thermal resistance material M1 and the second thermal resistance material M2 may be, for example, vacuum or inert gas (for example, helium, argon or other suitable inert gas), but the present disclosure is not limited thereto. When the first thermal resistance material M1 and the second thermal resistance material M2 meets the aforesaid limitations, the sound insulation or heat insulation effect of electronic devices can be improved.

In one embodiment of the present disclosure, as shown in FIG. 1, the electronic device further comprises: adhesives 6 respectively disposed at two sides of the first frame 41 and the second frame 42. Thus, the first frame 41 is fixed between the first light-transmitting element 1 and the switchable light control element 3, and the second frame 42 is fixed between the second light-transmitting element 2 and the switchable light control element 3. More specifically, the adhesive 6 may be disposed between the first frame 41 and the first light-transmitting element 1, so the first frame 41 and the first light-transmitting element 1 may be attached to each other. The adhesive 6 may be disposed between the first frame 41 and the switchable light control element 3, so the first frame 41 and the switchable light control element 3 may be attached to each other. Similarly, the adhesive 6 may be disposed between the second frame 42 and the second light-transmitting element 2, so the second frame 42 and the second light-transmitting element 2 may be attached to each other. The adhesive 6 may be disposed between the second frame 42 and the switchable light control element 3, so the second frame 42 and the switchable light control element 3 may be attached to each other. In the present disclosure, the material of the adhesive 6 may comprise butyl adhesive, glass adhesive, optical adhesive (for example, UV curing adhesive), silicone adhesive, double-sided tape, hot melt adhesive, moisture curing adhesive, AB adhesive, polymer adhesive or a combination thereof, but the present disclosure is not limited thereto.

In one embodiment of the present disclosure, as shown in FIG. 1, the protective structure 5 is disposed between the first light-transmitting element 1 and the second light-transmitting element 2, a part of the switchable light control element 3 may be embedded into the protective structure 5, and the protective structure 5 may cover the side 3s of the switchable light control element 3. More specifically, the part of the switchable light control element 3 embedded into the protective structure 5 may has a width W1 greater than or equal to 1 mm and less than or equal to 8 mm (that is, 1 mm≤W1≤8 mm). For example, the width W1 of the part may be greater than or equal to 1 mm and less than or equal to 6 mm (that is, 1 mm≤W1≤6 mm), or the width W1 of the part may be greater than or equal to 2 mm and less than or equal to 5 mm (that is, 2 mm≤W1≤5 mm), but the present disclosure is not limited thereto. When a part of the switchable light control element 3 is embedded into the protective structure 5 (that is, the width W1 of the part meets the aforesaid ranges), the contact area between the protective structure 5 and the switchable light control element 3 can be increased, and the switchable light control element 3 is less likely to be damaged by being pressed, thereby improving reliability.

In one embodiment of the present disclosure, the thickness T5 of the switchable light control element 3 may be between 0.5 mm to 8 mm (that is, 0.5 mm≤T5≤8 mm), between 0.5 mm to 6 mm (that is, 0.5 mm≤T5≤6 mm), between 1 mm to 5 mm (that is, 1 mm≤T5≤5 mm), between 1 mm to 4 mm (that is, 1 mm≤T5≤4 mm) or between 1 mm to 3 mm (that is, 1 mm≤T5≤3 mm), but the present disclosure is not limited thereto. The “thickness of the switchable light control element” refers to, for example, the average distance between the upper surface and the lower surface of the switchable light control element 3 at any three points in the normal direction Z of the first light-transmitting element 1 (that is, in a cross-section). In one embodiment of the present disclosure, the first thickness T1 of the first chamber C1 and the second thickness T2 of the second chamber C2 may respectively be greater than or equal to the thickness T5 of the switchable light control element 3, but the present disclosure is not limited thereto. In one embodiment of the present disclosure, the first thickness T1 of the first chamber C1 and the second thickness T2 of the second chamber C2 may respectively be less than the thickness T5 of the switchable light control element 3, but the present disclosure is not limited thereto. In one embodiment of the present disclosure, the thickness T3 of the first light-transmitting element 1 may be greater than the thickness T5 of the switchable light control element 3, but the present disclosure is not limited thereto. In one embodiment of the present disclosure, the thickness T4 of the second light-transmitting element 2 may be greater than the thickness T5 of the switchable light control element 3, but the present disclosure is not limited thereto.

In one embodiment of the present disclosure, as shown in FIG. 3A and FIG. 3B, the switchable light control element may be, for example, a light absorption switching element 31. Since the light absorption switching element 31 can be switchable between light-shielding and light-transmitting states, the electronic device can be switched between light shielding mode and light transmission mode when the switchable light control element is the light absorption switching element 31. The light absorption switching element 31 will be described in detail below.

In the present embodiment, as shown in FIG. 3A and FIG. 3B, the light absorption switching element 31 may comprise: a third substrate 311; a fourth substrate 312 disposed opposite to the third substrate 311; a first light modulation layer 313 disposed between the third substrate 311 and the fourth substrate 312; a first electrode layer 314 disposed between the third substrate 311 and the first light modulation layer 313; and a second electrode layer 315 disposed between the fourth substrate 312 and the first light modulation layer 313, wherein the first light modulation layer 313 comprises a liquid crystal material 3131 and/or a dye material 3132. FIG. 3A shows an example of applying voltages to the first electrode layer 314 and the second electrode layer 315 respectively to generate a vertical electric filed between the first electrode layer 314 and the second electrode layer 315, thereby controlling the arrangement of the liquid crystal material 3131 and/or the dye material 3132 in the first light modulation layer 313, so the light absorption switching element 3 can be switched between the light shielding state and the light transmission state, but the present disclosure is not limited thereto. In other embodiments (not shown in the figure), the first electrode layer 314 and the second electrode layer 315 may be, for example, formed on the same substrate. For example, the first electrode layer 314 and the second electrode layer 315 may be, for example, formed between the third substrate 311 and the first light modulation layer 313. The first electrode layer 314 and the second electrode layer 315 may be the same electrode layer or different electrode layers. When the first electrode layer 314 and the second electrode layer 315 are located in the same layer, a voltage is applied between the first electrode layer 314 and the second electrode layer 315 to achieve an in-plain switching structure (IPS), but the present disclosure is not limited thereto. When the first electrode layer 314 and the second electrode layer 315 are located in different layers, a voltage is applied to the first electrode layer 314 and the second electrode layer 315 to achieve a fringe filed switching structure (FFS), but the present disclosure is not limited thereto.

In one embodiment of the present disclosure, when no voltage is applied to the first electrode layer 314 and the second electrode layer 315, as shown in FIG. 3A, the long axes of the liquid crystal material 3131 and the dye material 3132 in the first light modulation layer 313 are, for example, approximately perpendicular to the polarization direction of the incident light L1 (for example, the horizontal polarization direction or the vertical polarization direction), the incident light L1, for example, is not easily absorbed by the dye material 3132, and the light absorption switching element 31 is present in a transmitting state. When a voltage is respectively applied to the first electrode layer 314 and the second electrode layer 315 to form a vertical electric field between the first electrode layer 314 and the second electrode layer 315, as shown in FIG. 3B, as the liquid crystal material 3131 is, for example, negative liquid crystals, the long axes of most of the liquid crystal material 3131 and/or the dye material 3132 in the first light modulation layer 313 are, for example, approximately parallel to the polarization direction of the incident light L1 (for example, the vertical polarization direction), the incident light L1, for example, is easily absorbed by the dye material 3132, and the light absorption switching element 31 is present in a light shielding state or a gray scale state. The above-mentioned method of switching the light absorption switching element 31 between the light-shielding state and the light-transmitting state is only an example, and the light-shielding state and the light-transmitting state may be switched through other methods.

In the present disclosure, the same or different materials may be used to prepare the third substrate 311 and the fourth substrate 312, and the material of the third substrate 311 and the fourth substrate 312 may be respectively referred to that of the first substrate 11 or the second substrate 12, and are not described again here. In the present disclosure, the first light modulation layer 313 may be guest host type liquid crystal (GHLC), for example, including the liquid crystal material 3131 and the dye material 3132, and the liquid crystal material may comprise negative liquid crystals, but the present disclosure is not limited thereto. In the present disclosure, the dye material 3132 may comprise a dichroic dye, which has absorptivity for light with a wavelength range from, for example, 380 nm to 780 nm (380 nm≤wavelength≤780 nm). The absorption color of the dye material 3132 may include, for example, black, purple, orange, blue, other colors or a combination thereof, but the present disclosure is not limited thereto. In the present disclosure, the same or different material may be used to prepare the first electrode layer 314 and the second electrode layer 315, and the material of the first electrode layer 314 and the second electrode layer 315 may include a transparent material, such as a metal oxide, an alloy thereof or a combination thereof, but the present disclosure is not limited thereto. Suitable metal oxide includes, but is not limited to, indium tin oxide (ITO), indium zinc oxide (IZO), indium tin zinc oxide (ITZO), indium gallium zinc oxide (IGZO) or a combination thereof.

The above is only an example. The liquid crystal material 3131 of the first light modulation layer 313 may be any suitable liquid crystal material (for example, cholesterol liquid crystal, twisted nematic liquid crystal (TN), polymer dispersed liquid crystal (PDLC), polymer network liquid crystal (PNLC), polymer stabilized cholesterol structure (PSCT)) according to the needs, and the liquid crystal is not limited to positive liquid crystal or negative liquid crystal. In other embodiments (not shown in the figure), the first light modulation layer 313 may include an electrochromic material, a suspended particle device (SPD) or any other suitable material applicable to light modulation, but the present disclosure is not limited thereto.

In one embodiment of the present disclosure, as shown in FIG. 4A and FIG. 4B, the switchable light control element may be, for example, a light scattering switching element 32. The light scattering switching element 32 can be switched between the foggy state and the light-transmitting state, so the electronic device can be switched between light shielding mode and light transmission mode when the switchable light control element is the light scattering switching element 32. The light scattering switching element 32 will be described in detail below.

In the present embodiment, as shown in FIG. 4A and FIG. 4B, the light scattering switching element 32 may comprise: a fifth substrate 321; a sixth substrate 322 disposed opposite to the fifth substrate 321; a second light modulation layer 323 disposed between the fifth substrate 321 and the sixth substrate 322; a third electrode layer 324 disposed between the fifth substrate 321 and the second light modulation layer 323; and a fourth electrode layer 325 disposed between the sixth substrate 322 and the second light modulation layer 323, wherein the second light modulation layer 323 comprises a liquid crystal material 3231 or other suitable adjustable light scattering materials. By applying a voltage to the third electrode layer 324 and the fourth electrode layer 325 to generate a vertical electric field, the arrangement of the liquid crystal material 3231 in the second light modulation layer 323 can be controlled, and the light scattering switching element 32 can be switched between the foggy state and the light-transmitting state.

In other embodiments (not shown in the figure), the third electrode layer 324 and the fourth electrode layer 325 may be, for example, formed on the same substrate, and the third electrode layer 324 and the fourth electrode layer 325 may be, for example, formed between the fifth substrate 321 and the second light modulation layer 323. The third electrode layer 324 and the fourth electrode layer 325 may be the same electrode layer or different electrode layers. When the third electrode layer 324 and the fourth electrode layer 325 are located in the same layer, a voltage is applied between the third electrode layer 324 and the fourth electrode layer 325 to achieve, for example, an in-plane switching structure (IPS), but the present disclosure is not limited thereto. When the third electrode layer 324 and the fourth electrode layer 324 are located in different layers, a voltage is applied to the third electrode layer 324 and the fourth electrode layer 324 to achieve, for example, a fringe field switching structure (FFS), but the present disclosure is not limited thereto.

When no voltage is applied to the third electrode layer 324 and the fourth electrode layer 325, as shown in FIG. 4A, the liquid crystal material 3231 in the second light modulation layer 323, for example, is irregularly arranged. At this time, most of the incident light L2 is scattered when passing through the liquid crystal material 3231 (for example, cholesterol liquid crystal) arranged in this way, making the light scattering switching element 32 present in a foggy state. When a voltage (for example, a vertical electric filed) is applied to the third electrode layer 324 and the fourth electrode layer 325, as shown in FIG. 4B, the liquid crystal material 3231 in the second light modulation layer 323, for example, is regularly arranged (for example, the long axis of the liquid crystal material 3231 is arranged along the direction of the electric filed). At this time, most of the incident light L2 can pass through the light scattering switching element 32, making the light scattering switching element 32 present in a transmitting state. The above-mentioned method of switching the light scattering switching element 32 between the foggy state and the transmitting state is only an example, and the switching may be performed through other methods.

In the present disclosure, the same or different materials may be used to prepare the fifth substrate 321 and the sixth substrate 322. The materials of the fifth substrate 321 and the sixth substrate 322 may be referred to that of the first substrate 11 or the second substrate 12 respectively and are not described again here. In the present disclosure, the liquid crystal material 3231 of the second light modulation layer 323 may comprise polymer stabilized cholesteric texture (PSCT), polymer-dispersed liquid crystal (PDLC), polymer network liquid crystal (PNLC), other suitable liquid crystal material or a combination thereof, but the present disclosure is not limited thereto. In the present disclosure, the same or different materials may be used to prepare the third electrode layer 324 and the fourth electrode layer 325, and the materials of the third electrode layer 324 and the fourth electrode layer 325 may be referred to that of the first electrode layer 321 or the second electrode layer 322 respectively, and are not described again here.

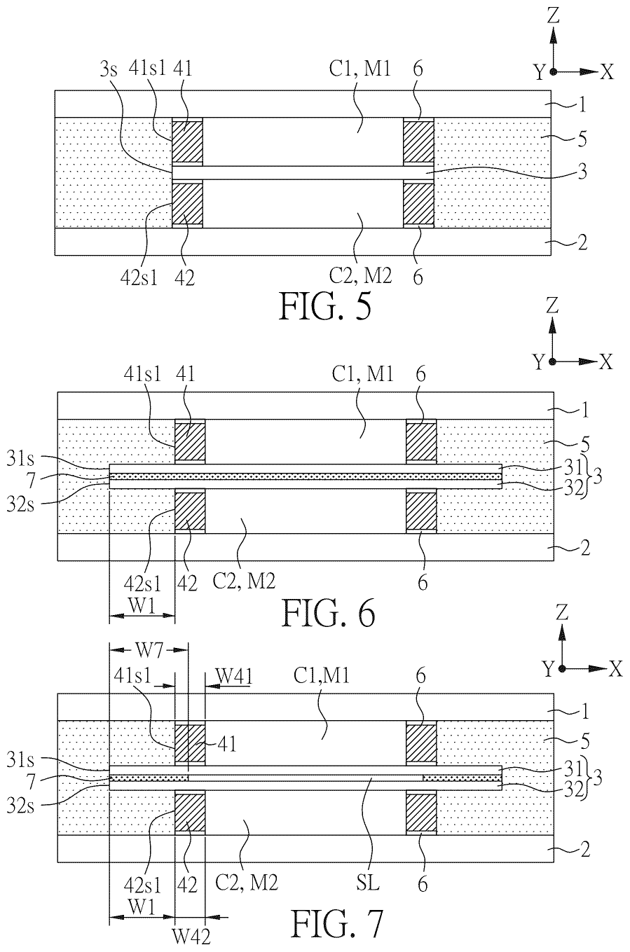

FIG. 5 is a cross-sectional schematic view of an electronic device according to one embodiment of the present disclosure. The electronic device of FIG. 5 is similar to that of FIG. 1, except for the following differences.

In one embodiment of the present disclosure, as shown in FIG. 5, the switchable light control element 3 of the electronic device, for example, may not be embedded into the protective structure 5, the protective structure 5 may contact the side 3s of the switchable light control element 3, and the inner side of the protective structure 5 may be substantially aligned with the side 3s of the switchable light control element 3. In other words, the width W1 indicated in FIG. 1 may be 0 in the present embodiment, or the first outer side 41s1 and/or the second outer side 42s1 may be approximately aligned with the side 3s of the switchable light control element 3. In other embodiments (not shown in the figure), the switchable light control element 3 may also be slightly retracted in the first frame 41 or the second frame 42, that is, the first outer side 41s1 and the second outer side 42s1 may be protruded from the side 3s of the switchable light control element 3.

Other features of the present embodiment are as described above and will not be repeated here.

FIG. 6 is a cross-sectional schematic view of an electronic device according to one embodiment of the present disclosure. The electronic device of FIG. 6 is similar to that of FIG. 1, except for the following differences.

In one embodiment of the present disclosure, as shown in FIG. 6, the switchable light control element 3 of the electronic device may comprise a light absorption switching element 31 and a light scattering switching element 32. More specifically, the switchable light control element 3 comprises: the light absorption switching element 31 disposed between the first light-transmitting element 1 and the light scattering switching element 32; and the light scattering switching element 32 disposed between the second light-transmitting element 2 and light absorption switching element 31. In the present embodiment, as shown in FIG. 6, compared to the light scattering switching element 32, the light absorption switching element 31 is disposed closer to the first light-transmitting element 1 (for example, near the outdoors), but the present disclosure is not limited thereto. In other embodiments, the position of the light absorption switching element 31 and the light scattering switching element 32 may be switched, that is, compared to light scattering switching element 32, the light absorption switching element 31 may be disposed closer to the second light-transmitting element 2 (for example, near the room). In the present embodiment, since the switchable light control element 3 comprises the light absorption switching element 31 and the light scattering switching element 32, the penetration of light incident from the first light-transmitting element 1 or the second light-transmitting element 2 can be selectively adjusted as needed by switching the light-shielding mode, light transmitting mode or other gray scale mode of the light absorption switching element 31 and the light scattering switching element 32.

In one embodiment of the present disclosure, as shown in FIG. 6, an adhesion element 7 may be included between the light absorption switching element 31 and the light scattering switching element 32 to attach the light absorption switching element 31 and the light scattering switching element 32. In the present disclosure, the adhesion element 7 may be a transparent material, and suitable material may include polyvinyl butyral (PVB), ethylene vinyl acetate (EVA), optical clear adhesive (OCA), optical clear resin (OCR), other suitable materials or a combination of thereof, but the present disclosure is not limited thereto. In one embodiment of the present disclosure, the adhesion element 7 may be approximately overlapped with the light absorption switching element 31 and the light scattering switching element 32 in the switchable light control element 3. In one embodiment of the present disclosure, the adhesion element 7 may be overlapped with the first chamber C1 and/or the first chamber C2. In one embodiment of the present disclosure, a projection area of the adhesion element 7 on the first light-transmitting element 1 may be equal to or less than a projection area of the light absorption switching element 31 or the light scattering switching element 32 on the first light-transmitting element 1.

In the present disclosure, in a cross section, the sizes (widths or thicknesses) of the light absorption switching element 31 and the light scattering switching element 32 may be approximately the same, but the present disclosure is not limited thereto. In other embodiments (not shown in the figure), the sizes (widths or thicknesses) of the light absorption switching element 31 and the light scattering switching element 32 may be different.

In the present disclosure, other features of the electronic device and the detail features of the light absorption switching element 31 and the light scattering switching element 32 may be referred to above, and are not described again here. In addition, in one embodiment of the present disclosure (not shown in the figure), the switchable light control element 3 of the electronic device may not be embedded into the protective structure 5, that is the light absorption switching element 31 and the light scattering switching element 32, for example, may not be embedded into the protective structure 5. That is, the side 31s of the light absorption switching element 31 and the side 32s of the light scattering switching element 32 may be, for example, approximately aligned with the first outer side 41s1 and/or the second outer side 42s1. The protective structure 5 may respectively contact the side 31s of the light absorption switching element 31, the side 32s of the light scattering switching element 32, the first outer side 41s1 and/or the second outer side 42s1. In other words, the width W1 shown in FIG. 6 may be 0 in other embodiments of the present disclosure. In one embodiment of the present disclosure, the widths of the light absorption switching element 31 and the light scattering switching element 32 in the switchable light control element 3 may be the same or different.

FIG. 7 is a cross-sectional schematic view of an electronic device according to one embodiment of the present disclosure. The electronic device shown in FIG. 7 is similar to that shown in FIG. 6, except for the following differences.

In one embodiment of the present disclosure, as shown in FIG. 7, an adhesion element 7 may be included between the light absorption switching element 31 and the light scattering switching element 32 to attach the light absorption switching element 31 and the light scattering switching element 32, wherein the adhesion element 7 may be a patterned adhesion element. More specifically, a spacing layer SL may be included between the light absorption switching element 31 and the light scattering switching element 32, and the adhesion element 7 may be disposed surrounding the spacing layer SL. In the normal direction Z of the first light-transmitting element 1, a part of the spacing layer SL may be at least partially overlapped with the first chamber C1 or the second chamber C2, and a part of the adhesion element 7 may be overlapped with the first frame 41, the second frame 42 or the protective structure 5. In one embodiment of the present disclosure, a projection area of the spacing layer SL on the first light-transmitting element 1 may be greater than or equal to a projection area of the first chamber C1 or the second chamber C2 on the first light-transmitting element 1. In one embodiment of the present disclosure (not shown in the figure), a projection area of the spacing layer SL on the first light-transmitting element 1 may be less than a projection area of the first chamber CI or the second chamber C2 on the first light-transmitting element 1. In some embodiments, in a cross section, the width W7 of the adhesion element 7 may be greater than the width W41 of the first frame 41 or the width W42 of the second frame 42. In some embodiments, in a cross section, the width W7 of the adhesion element 7 may be greater than the width W1.

In the present disclosure, the adhesion element 7 may be a transparent or non-transparent material, and suitable material may comprise polyvinyl butyral (PVB), ethylene vinyl acetate (EVA), optical clear adhesive (OCA), optical clear resin (OCR), other suitable materials or a combination thereof, but the present disclosure is not limited thereto. In the present disclosure, the spacing layer SL may be vacuum or comprise inert gas (for example, helium, argon, etc.), but the present disclosure is not limited thereto.

In the present disclosure, other features of the electronic device and the detail features of the light absorption switching element 31 and the light scattering switching element 32 may be as described above, and are not described again here. In addition, in one embodiment of the present disclosure (not shown in the figure), the switchable light control element 3 of the electronic device may not be embedded into the protective structure 5, that is the light absorption switching element 31 and the light scattering switching element 32 may not be embedded into the protective structure 5. In other words, the width W1 shown in FIG. 7 may be 0 in other embodiments of the present disclosure.

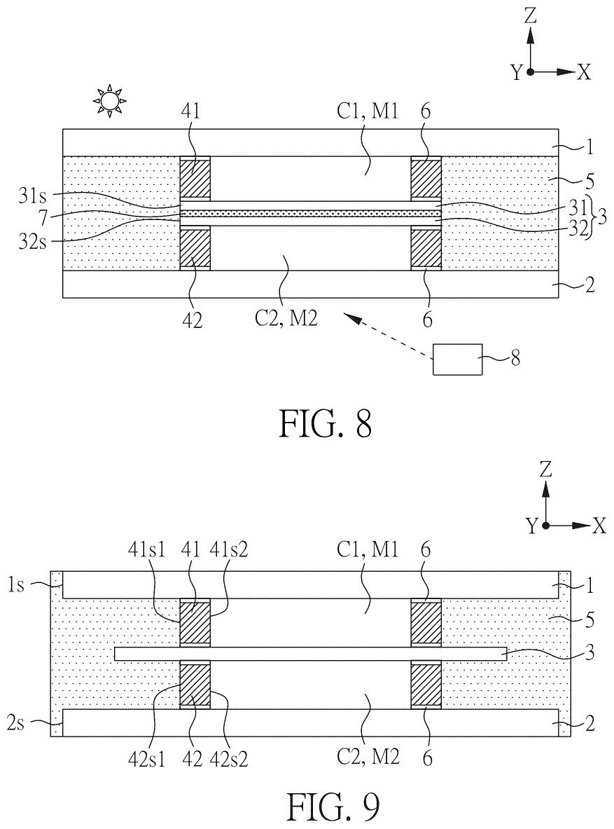

FIG. 8 is a cross-sectional schematic view of an electronic device according to one embodiment of the present disclosure. The electronic device of FIG. 8 is similar to that shown in FIG. 6, except for the following differences. In addition, the sun pattern in FIG. 8 indicates the outdoor side.

In one embodiment of the present disclosure, as shown in FIG. 8, the switchable light control element 3 of the electronic device may not be embedded into the protective structure 5, that is, the light absorption switching element 31 and the light scattering switching element 32 may not be embedded into the protective structure 5. The inner side of the protective structure 5 may be substantially aligned with the side 31s of the light absorption switching element 31 and the side 32s of the light scattering switching element 32 respectively. In other words, the width W1 shown in FIG. 6 is 0 in the present embodiment.

In one embodiment of the present disclosure, as shown in FIG. 8, the electronic device may further comprise an image generator 8 for generating an image, wherein the light scattering switching element 32 is disposed between the light absorption switching element 31 and the image generator 8. In the projection mode, the image generated by the image generator 8 may sequentially pass through the light scattering switching element 32 and the light absorption switching element 31 to be displayed. By combining with the image generator 8, the electronic device has the projection function to achieve the effect of displaying images (including text or pictures, but not limited to these). In one embodiment of the present disclosure, compared to the light scattering switching element 32, the light absorption switching element 31 can be disposed closer to the outdoor side.

In one embodiment of the present disclosure, as shown in FIG. 8, the electronic device, for example, may be switched between the light shielding mode and the transmitting mode. In addition, the electronic device of the present embodiment may comprise an image generator 8, which can be switched to the projection mode when needed to display images. The corresponding component relationship between each mode can be shown in Table 1 below.

TABLE 1

| | Transmitting | Light shielding | |
|---|---|---|---|
| | mode | mode | Projection mode |
| Image generator | Not started | Not started | Started |
| Light absorption | Transmitting | Light shielding | Suitable grey |
| switching element | state | state | state |
| Light scattering | Transmitting | Foggy state | Foggy state |
| switching element | state | | |

When the electronic device is in the transmitting mode, it is not necessary to start the image generator 8, and the light absorption switching element 31 and the light scattering switching element 32 may respectively be in the transmitting state. Thus, light may be respectively pass through the light absorption switching element 31 and the light scattering switching element 32, and the electronic device is in the transmitting state. When the electronic device is in the light shielding mode, for example, it is not necessary to start the image generator 8, and the light absorption switching element 31 is in the light shielding state while the light scattering switching element 32 is in the foggy state. More specifically, when light passes through the light absorption switching element 31, the incident light is easily absorbed and the light absorption switching element 31 is in the light shielding state; when light passes through the light scattering switching element 32, the incident light is easily scattered and the light scattering switching element 32 is in the foggy state, so the electronic device is in the light shielding state. When the electronic device is in the projection mode, the image generator 8 is started, and the light absorption switching element 31 is in a suitable grey state while the light scattering switching element 32 is in the foggy state, so the images generated by the image generator 8 may sequentially passes through the light scattering switching element 32 and the light absorption switching element 31 to be displayed.

In the present disclosure, other features of the electronic device and detail features of the light absorption switching element 31 and the light scattering switching element 32 may be as described above, and are not described again here.

FIG. 9 is a cross-sectional schematic view of an electronic device according to one embodiment of the present disclosure. The electronic device of FIG. 9 is similar to that of FIG. 1, except for the following differences.

In one embodiment of the present disclosure, as shown in FIG. 9, the protective structure 5 may be disposed between the first light-transmitting element 1 and the second light-transmitting element 2, and the protective structure 5 covers or contacts the side Is of the first light-transmitting element 1, the side 2s of the second light-transmitting element 2, the side of the first frame 41 (for example, the first outer side 41s1) and the side of the second frame 42 (for example, the second outer side 42s1). Thus, the contact area between the protective structure 5 and the first light-transmitting element 1 and the second light-transmitting element 2 can be increased, thereby improving the reliability of the electronic device.

In the present disclosure, the material of the protective structure 5 may be referred to the above and is not described again here. In addition, other features of the electronic device and detail features of the light absorption switching element 31 and the light scattering switching element 32 are as described above and are not described again here.

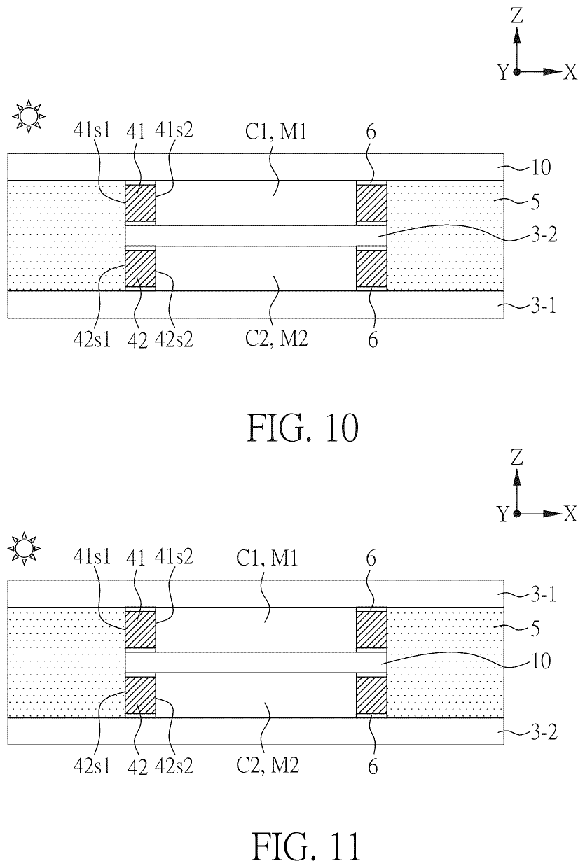

FIG. 10 is a cross-sectional schematic view of an electronic device according to one embodiment of the present disclosure. The sun pattern in FIG. 10 indicates the outdoor side.

In one embodiment of the present disclosure, as shown in FIG. 10, the electronic device may comprise: a light-transmitting element 10; a first switchable light control element 3-1 disposed corresponding to the light-transmitting element 10; and a second switchable light control element 3-2 disposed between the light-transmitting element 10 and the first switchable light control element 3-1; wherein a first chamber C1 is between the light-transmitting element 10 and the second switchable light control element 3-2, a second chamber C2 is between the first switchable light control element 3-1 and the second switchable light control element 3-2, the first switchable light control element 3-1 comprises one of the light absorption switching element and the light scattering switching element and the second switchable light control element 3-2 comprises the other one of the light absorption switching element and the light scattering switching element.

In one embodiment of the present disclosure, as shown in FIG. 10, the electronic device may comprise: a first frame 41 disposed between the light-transmitting element 10 and the second switchable light control element 3-2 to form the first chamber C1; a second frame 42 disposed between the first switchable light control element 3-1 and the second switchable light control element 3-2 to form the second chamber C2; and a protective structure 5 disposed between the light-transmitting element 10 and the first switchable light control element 3-1, wherein the protective structure 5 covers the side of the first frame 41 and the side of the second frame 42. More specifically, in the present disclosure, the first frame 41 and the second frame 42 may respectively have a surrounding structure. Thus, in a cross section (for example, FIG. 10), the first frame 41 may have a first outer side 41s1 and a first inner side 41s2, the second frame 42 may have a second outer side 42s1 and a second inner side 42s2, wherein the protective structure 5 may respectively contact the first outer side 41s1 of the first frame 41 and the second outer side 42s1 of the second frame 42. In addition, the electronic device may further comprise: a first thermal resistance material M1 disposed in the first chamber C1; and a second thermal resistance material M2 disposed in the second chamber C2, wherein the first inner side 41s2 of the first frame 41 may contact the first thermal resistance material M1, and the second inner side 42s2 of the second frame 42 may contact the second thermal resistance material M2.

In the electronic device of the present disclosure, by combining the light-transmitting element 10 with the first switchable light control element 3-1 and the second switchable light control element 3-2 to form two chambers (for example, the first chamber C1 and the second chamber C2) and filling suitable thermal resistance materials in the chambers, the electronic device can have the functions of heat insulation, sound insulation, blocking external light or penetrating external light. The first thermal resistance material M1 and the second thermal resistance material M2 may be referred to the above. Similarly, the thicknesses of the first chamber C1 and the second chamber C2 or the relationship between the thicknesses of the first chamber C1 and the second chamber C2 and the thickness of other elements may be referred to above.

In one embodiment of the present disclosure, as shown in FIG. 10, the electronic device may further comprise: an adhesive 6 respectively disposed at two sides of the first frame 41 and the second frame 42 so that the first frame 41 is fixed between the light-transmitting element 10 and the second switchable light control element 3-2, and the second frame 42 is fixed between the first switchable light control element 3-1 and the second switchable light control element 3-2. More specifically, the adhesive 6 may be disposed between the first frame 41 and the light-transmitting element 10, so the first frame 41 may be attached to the light-transmitting element 10; the adhesive 6 may be disposed between the first frame 41 and the second switchable light control element 3-2, so the first frame 41 may be attached to the second switchable light control element 3-2. Similarly, the adhesive 6 may be disposed between the second frame 42 and the first switchable light control element 3-1, so the second frame 42 may be attached to the first switchable light control element 3-1; the adhesive 6 may be disposed between the second frame 42 and the second switchable light control element 3-2, so the second frame 42 may be attached to the second switchable light control element 3-2.

In one embodiment of the present disclosure, the first switchable light control element 3-1 may be, for example, a light scattering switching element 32 (as shown in FIG. 4A and FIG. 4B), and the second switchable light control element 3-2 may be, for example, a light absorption switching element 31 (as shown in FIG. 3A and FIG. 3B), but the present disclosure is not limited thereto. In another embodiment of the present disclosure, the first switchable light control element 3-1 may be, for example, a light absorption switching element 31 (as shown in FIG. 3A and FIG. 3B), and the second switchable light control element 3-2 may be, for example, a light scattering switching element 32 (as shown in FIG. 4A and FIG. 4B). In one embodiment of the present disclosure, as shown in FIG. 10, when the electronic device is a smart window, compared to the first switchable light control element 3-1, the second switchable light control element 3-2 may be closer to the outdoor side, but the present disclosure is not limited thereto.

In the present disclosure, the material of the light-transmitting element 10 may be, for example, as those of the first light-transmitting element 1 or the second light-transmitting element 2 described above, and the light-transmitting element 10 may respectively have a single or multi-layer structure as shown in FIG. 2, and are not described again here. In the present disclosure, the materials of the first frame 41, the second frame 42, the adhesive 6, the first thermal resistance material M1 and the second thermal resistance material M2 may be as described above, and are not described again here. In addition, other features of the electronic device and detail features of the light absorption switching element 31 and the light scattering switching element 32 may be as described above and are not described again here.

FIG. 11 is a cross-sectional schematic view of an electronic device according to one embodiment of the present disclosure. The sun pattern in FIG. 11 indicates the outdoor side.

In one embodiment of the present disclosure, as shown in FIG. 11, the electronic device may comprise: a first switchable light control element 3-1; a second switchable light control element 3-2 opposite to the first switchable light control element 3-1; and a light-transmitting element 10 disposed between the first switchable light control element 3-1 and the second switchable light control element 3-2, wherein a first chamber C1 is between the first switchable light control element 3-1 and the light-transmitting element 10, a second chamber C2 is between the second switchable light control element 3-2 and the light-transmitting element 10, the first switchable light control element 3-1 comprises one of the light absorption switching element and the light scattering switching element, and the second switchable light control element 3-2 comprises the other of the light absorption switching element and the light scattering switching element.

In one embodiment of the present disclosure, as shown in FIG. 11, the electronic device may comprise: a first frame 41 disposed between the light-transmitting element 10 and the first switchable light control element 3-1 to form the first chamber C1; a second frame 42 disposed between the second switchable light control element 3-2 and the light-transmitting element 10 to form the second chamber C2; and a protective structure 5 disposed between the first switchable light control element 3-1 and the second switchable light control element 3-2, wherein the protective structure 5 covers the side of the first frame 41 and the side of the second frame 42. More specifically, in the present disclosure, the first frame 41 and the second frame 42 may respectively have a surrounding structure. Thus, in a cross section (for example, FIG. 11), the first frame 41 may have a first outer side 41s1 and a first inner side 41s2, and the second frame 42 may have a second outer side 42s1 and a second inner side 42s2. The protective structure 5 may respectively contact the first outer side 41s1 of the first frame 41 and the second outer side 42s1 of the second frame 42. In addition, the electronic device may further comprise: a first thermal resistance material M1 disposed in the first chamber C1; and a second thermal resistance material M2 disposed in the second chamber C2, wherein the first inner side 41s2 of the first frame 41 may contact the first thermal resistance material M1, and the second inner side 42s2 of the second frame 42 may contact the second thermal resistance material M2.

In the electronic device of the present disclosure, by combining the light-transmitting element 10 with the first switchable light control element 3-1 and the second switchable light control element 3-2 to form two chambers (for example, the first chamber C1 and the second chamber C2) and filling suitable thermal resistance materials, the electronic devices can have the effects of heat insulation, sound insulation, blocking external light or penetrating external light. The first thermal resistance material M1 and the second thermal resistance material M2 may be referred to above. Similarly, the thicknesses of the first chamber C1 and the second chamber C2 or the relationship between the thicknesses of the first chamber C1 and the second chamber C2 and the thickness of other elements may also referred to those described above.

In one embodiment of the present disclosure, as shown in FIG. 11, the electronic device may further comprise: an adhesive 6 respectively disposed at two sides of the first frame 41 and the second frame 42, so the first frame 41 is fixed between the light-transmitting element 10 and the first switchable light control element 3-1, and the second frame 42 is fixed between the light-transmitting element 10 and the second switchable light control element 3-2. More specifically, the adhesive 6 may be disposed between the first frame 41 and the first switchable light control element 3-1, so the first frame 41 may be attached to the first switchable light control element 3-1. The adhesive 6 may be disposed between the first frame 41 and the light-transmitting element 10, so the first frame 41 may be attached to the light-transmitting element 10. Similarly, the adhesive 6 may be disposed between the second frame 42 and the light-transmitting element 10, so the second frame 42 may be adhered to the light-transmitting element 10. The adhesive 6 may be disposed between the second frame 42 and the second switchable light control element 3-2, so the second frame 42 may be attached to the second switchable light control element 3-2.

In one embodiment of the present disclosure, the first switchable light control element 3-1 may be, for example, a light absorption switching element 31 (as shown in FIG. 3A and FIG. 3B) and the second switchable light control element 3-2 may be, for example, a light scattering switching element 32 (as shown in FIG. 4A and FIG. 4B), but the present disclosure is not limited thereto. In another embodiment of the present disclosure, the first switchable light control element 3-1 may be, for example, a light scattering switching element 32 (as shown in FIG. 4A and FIG. 4B) and the second switchable light control element 3-2 may be, for example, a light absorption switching element 31 (as shown in FIG. 3A and FIG. 3B). In one embodiment of the present disclosure, as shown in FIG. 11, when the electronic device is a smart window, compared to the second switchable light control element 3-2, the first switchable light control element 3-1 may be closer to the outdoor side, but the present disclosure is not limited thereto.

In the present disclosure, the material of the light-transmitting element 10 may be, for example, as those of the first light-transmitting element 1 or the second light-transmitting element 2, and the light-transmitting element 10 may respectively have the single or multi-layer structure as shown in FIG. 2, and are not described again here. In the present disclosure, the materials of the first frame 41, the second frame 42, the adhesive 6, the first thermal resistance material M1 and the second thermal resistance material M2 are as described above, and are not described again here. In addition, other features of the electronic device and detail structures of the light absorption switching element 31 and the light scattering switching element 32 are as described above and are not described again here.

In the present disclosure, the electronic device may selectively comprise an anti-glare layer (not shown in the figure), an anti-fouling layer (not shown in the figure) or an anti-scratch layer (not shown in the figure), and the above elements may be, for example, disposed closer to the outdoor side. The protective structure 5 may have single layer material or multi-layer material. In the present disclosure, the electronic device may respectively comprise a photo-conversion element (not shown in the figure, for example, a solar cell), the photo-conversion element may be, for example, set at any position that does not affect the switchable light control element 3 switching between light-transmitting, light-shielding (dark state) or foggy state, and the photo-conversion element, for example, is electrically connected to the switchable light control element 3.

In the present disclosure, the electronic device may be applied to any energy saving device comprising liquid crystal materials, thereby improving the light-shielding, heat-insulating and/or sound-isolating effects of electronic devices. In the present disclosure, the electronic device may be applied to, for example, electronic windows or other suitable applied products, but the present disclosure is not limited thereto.

The above specific embodiments should be interpreted as merely illustrative, and not to limit the rest of the present disclosure in any way, and the features between different embodiments can be mixed and matched for use as long as they do not conflict with each other.

Although the present disclosure has been explained in relation to its embodiment, it is to be understood that many other possible modifications and variations can be made without departing from the spirit and scope of the disclosure as hereinafter claimed.

1. An electronic device, comprising:
a first light-transmitting element;
a second light-transmitting element opposite to the first light-transmitting element; and
a switchable light control element disposed between the first light-transmitting element and the second light-transmitting element,
wherein a first chamber is between the first light-transmitting element and the switchable light control element, a second chamber is between the second light-transmitting element and the switchable light control element, and the switchable light control element comprises at least one of a light absorption switching element and a light scattering switching element.

2. The electronic device of claim 1, further comprising:
a first thermal resistance material disposed in the first chamber; and
a second thermal resistance material disposed on the second chamber,
wherein a thermal conductivity of the first thermal resistance material and the second thermal resistance material is less than 50×10⁻³ W·m⁻¹·K⁻¹ respectively.

3. The electronic device of claim 2, wherein the first thermal resistance material and the second thermal resistance material are vacuum or inert gas respectively.

4. The electronic device of claim 1, wherein in a normal direction of the first light-transmitting element, the first chamber has a first thickness, the second chamber has a second thickness, and the first thickness and the second thickness are respectively greater than or equal to 6 mm and less than or equal to 20 mm.

5. The electronic device of claim 1, further comprising:
a first frame disposed between the first light-transmitting element and the switchable light control element to form the first chamber;
a second frame disposed between the second light-transmitting element and the switchable light control element to form the second chamber; and
a protective structure disposed between the first light-transmitting element and the second light-transmitting element, wherein the protective structure covers a side of the first frame and a side of the second frame.

6. The electronic device of claim 5, further comprising: adhesive respectively disposed at two sides of the first frame and the second frame.

7. The electronic device of claim 1, further comprising: a protective structure disposed between the first light-transmitting element and the second light-transmitting element, wherein a part of the switchable light control element is embedded into the protective structure, and the protective structure covers a side of the switchable light control element.

8. The electronic device of claim 7, wherein the part of the switchable light control element embedded into the protective structure has a width greater than or equal to 1 mm and less than or equal to 8 mm.

9. The electronic device of claim 1, wherein a thickness of the first chamber and a thickness of the second chamber are respectively greater than or equal to a thickness of the switchable light control element.

10. The electronic device of claim 1, wherein a thickness of the first light-transmitting element is greater than a thickness of the switchable light control element.

11. The electronic device of claim 1, wherein a thickness of the first light-transmitting element is between 3 mm to 30 mm.

12. The electronic device of claim 1, wherein a thickness of the second light-transmitting element is between 3 mm to 30 mm.

13. The electronic device of claim 1, wherein a thickness of the switchable light control element is between 0.5 mm to 8 mm.

14. The electronic device of claim 1, wherein the switchable light control element comprises the light absorption switching element and the light scattering switching element.

15. An electronic device, comprising:
a light-transmitting element;
a first switchable light control element opposite to the light-transmitting element; and
a second switchable light control element disposed between the light-transmitting element and the first switchable light control element,
wherein a first chamber is between the light-transmitting element and the second switchable light control element, a second chamber is between the first switchable light control element and the second switchable light control element, the first switchable light control element comprises one of a light absorption switching element and a light scattering switching element, and the second switchable light control element comprises the other one of the light absorption switching element and the light scattering switching element.

16. The electronic device of claim 15, further comprising:
a first frame disposed between the light-transmitting element and the second switchable light control element to form the first chamber;
a second frame disposed between the first switchable light control element and the second switchable light control element to form the second chamber; and
a protective structure disposed between the light-transmitting element and the first switchable light control element, wherein the protective structure covers a side of the first frame and a side of the second frame.

17. The electronic device of claim 15, further comprising:
a first thermal resistance material disposed in the first chamber; and
a second thermal resistance material disposed in the second chamber,
wherein a thermal conductivity of the first thermal resistance material and the second thermal resistance material is less than 50×10⁻³ W·m⁻¹·K⁻¹ respectively.

18. An electronic device, comprising:
a first switchable light control element;
a second switchable light control element opposite to the first switchable light control element; and
a light-transmitting element disposed between the first switchable light control element and the second switchable light control element,
wherein a first chamber is between the first switchable light control element and the light-transmitting element, a second chamber is between the second switchable light control element and the light-transmitting element, the first switchable light control element comprises one of a light absorption switching element and a light scattering switching element, and the second switchable light control element comprises the other one of the light absorption switching element and the light scattering switching element.

19. The electronic device of claim 18, further comprising:
a first frame disposed between the light-transmitting element and the first switchable light control element to form the first chamber;
a second frame disposed between the second switchable light control element and the light-transmitting element to form the second chamber; and
a protective structure disposed between the first switchable light control element and the second switchable light control element, wherein the protective structure covers a side of the first frame and a side of the second frame.

20. The electronic device of claim 18, further comprising:
a first thermal resistance material disposed in the first chamber; and
a second thermal resistance material disposed in the second chamber,
wherein a thermal conductivity of the first thermal resistance material and the second thermal resistance material is less than 50×10⁻³ W·m⁻¹·K⁻¹ respectively.
